(19) United States
(12) Patent Application Publication
(10) Pub. No.: US 2002/0059218 A1
(43) Pub. Date: May 16, 2002

(54) SYSTEM AND METHOD FOR OBTAINING REAL TIME SURVEY INFORMATION FOR MEDIA PROGRAMMING USING INPUT DEVICE

(76) Inventors: KATHERINE GRACE AUGUST, MATAWAN, NJ (US); NORMAN R. SHAER, LOCUST, NJ (US); THEODORE SIZER II, LITTLE SILVER, NJ (US)

Correspondence Address: LANCE J LIEBERMAN, COHEN PONTANI LIEBERMAN & PAVANE, 551 FIFTH AVENUE, SUITE 1210, NEW YORK, NY, 10176

(21) Appl. No.: 09/237,503

(22) Filed: Jan. 26, 1999

(51) Int. Cl. G06F 7/00

(52) U.S. Cl. 707/5

(57) ABSTRACT

A system and method for monitoring media audience habits and for obtaining real time responses to survey queries posed to a user from a survey provider concerning programming experienced by the user. A media program identifier located in an environment containing a primary media receiving device identifies media programming experienced by the user on the primary device. An input unit also located in the environment containing the primary receiving device obtains user identification and user demographics information by receiving responses to specific queries from the user. Survey queries concerning programming experienced by the user are provided to the user on the input unit or the primary receiving device for responding thereto. The programming identification, user identification and demographics information as well as survey query responses are then transmitted to a survey provider for use in deriving media program ratings information.

### BACKGROUND OF THE INVENTION

I. Field of the Invention

The present invention pertains to audience measurement for media, program and advertising ratings. More particularly, the present invention relates to a method and apparatus for the gathering of media audience survey information concerning media audience viewing habits.

II. Description of the Related Art

Information concerning viewing habits of media audience such as television or internet audiences is of great value. Such information is used, for example, by television networks and cable television stations to establish advertising rates and is also used by advertisers to gauge the effectiveness of television advertising campaigns, e.g. to determine the number of viewers that see a particular advertisement. Royalties are paid based upon air play, private play, and access by various means.

Audience measurement for media, program and advertising ratings consists of the identification of viewers (demographics and number), as well as the identification of the particular programs or advertisements that are viewed. For identifying or tracking programs or advertisements (“ads”), such programs/ads can be encoded with a unique code, as for example an electronic “water mark” which is unique for each program as described in U.S. Pat. No. 5,663,766, issued on Sep. 2, 1997. The code can be detected by a detector or probe placed in a video monitor, such as a television, computer or peripheral equipment such as a video cassette recorder (VCR) or set-top box, or simply located in the television environment, e.g. in a television room. However, such a device does not gather any information about the number or characteristics of the viewers actually watching a particular program. Moreover, as the detector element is typically contained in either the television or a peripheral device, no information is recorded or received if the video signal is obtained, output from, or displayed on a device which is not associated with the detector. For example, if the detector is placed within a television and the signal is received through a VCR or set-top box, then the code will not be detected.

Drawbacks of prior developed audience measurement techniques are that viewers may forget or find it inconvenient to input demographic information, which is desired for accurate ratings data. Also, when (as is common) a program is viewed elsewhere, such information must nevertheless be included in the recorded ratings data requiring that the viewer recall, from memory, the prior programs or advertisements that were viewed and manually record the information.

Other drawbacks include expense of electronic probes for televisions, unique set top boxes to provide devices to collect viewer specific information, and static programming. Proliferation of media sources and terminal devices makes customized equipment ineffective in the marketplace and makes data gathering for multiple media vehicles difficult.

### SUMMARY OF THE INVENTION

Survey information pertaining to media audience demographics and viewing habits is obtained in real time, in accordance with the invention, by employing a combination of a media content identifier device and a demographics and survey response input device. The input device also allows for delayed data entry by an audience member—such as a television viewer, who views programming at a remote video receiver and enters requested data upon returning to a primary receiver—and facilitates such delayed entry by providing a menu of program history of programming which may have been viewed at the remote video receiver.

The inventive apparatus and method receive information from an audience member of a primary media receiver, e.g. television, radio, computer, through an input device. In the case of a television audience member, such information may include the sex of the viewer and his usual television viewing times, as well as a preferred category of programming, e.g. drama, comedy, etc., and may be used to obtain demographics information of a viewing audience. A content identifier is provided for identifying the programming experience by the viewer, such as by receiving a unique code assigned to each program and advertisement. Survey information is obtained from an audience member who enters responses on the input device in response to query prompts which can be visibly displayed on, or audibly broadcast from, either the media receiver or input device. The survey information along with the program identification codes can then be correlated and provided to a survey provider for use, for example, in aggregating media ratings data.

Advantageously, by providing access to audio and/or video encoding/decoding in a non-intrusive architecture in accordance with the present invention, wherein separate detecting probes or devices connected to each video receiving device are not required for determining the identification of a received video signal, the cost of infrastructure is reduced. Since timing of monitoring is no longer an element of program/content identification, the invention is useable with various media. This timing independence also allows for easy installation of detection equipment while increasing accuracy of program/content identification.

### BRIEF DESCRIPTION OF THE DRAWINGS

In the drawings:

The FIGURE illustrates an apparatus for obtaining media program and advertising ratings in accordance with the present invention.

### DETAILED DESCRIPTION OF THE PRESENTLY PREFERRED EMBODIMENTS

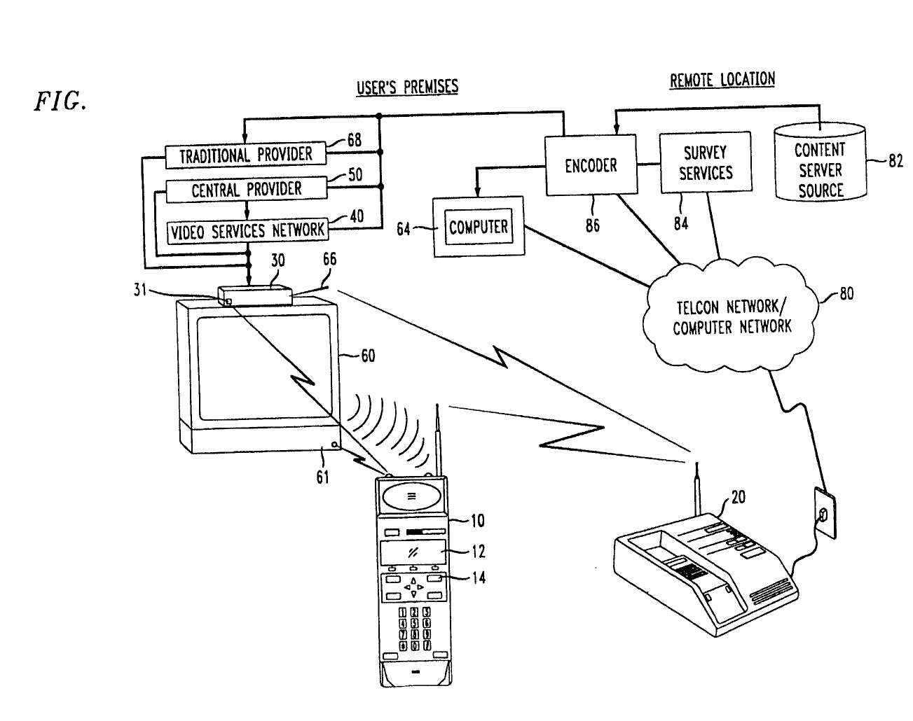

FIG. 1 shows an exemplary apparatus in accordance with the invention for gathering media viewer ratings information. The apparatus includes an input device 10 for receiving viewer input of information desired to be collected by a collector, such as viewer demographic information consisting of age, sex, average television viewing habits, etc. Input device 10 may be, for example, (1) an Analog Display Services Interface (ADSI) wireless telephone of the type disclosed in U.S. Pat. No. 5,394,461, the entire contents of which is incorporated by reference, (2) a cordless phone which operates in cooperation with a base station 20, or (3) a wireless remote control device for use in operating a television, as is known in the art. The input device 10 is preferably a portable device which provides interaction with other electronic media devices in a video viewing environment via radio frequency (RF) or infrared signals as more fully described in U.S. Pat. No. 5,671,267. As explained more fully below, input device 10 is used to gather from media audience members information such as may be used in ascertaining the demographics of the audience and responses to survey queries. The particular information sought may be indicated to the audience member through prompting by input device 10. The survey information concerning programming viewed on a video receiving device 60 is stored by input device 10 which also provides such stored information to a ratings service provider.

Video receiving device 60 may be a television, personal computer 64, workstation, etc. for displaying video signals. It may be interfaced with a set-top box 30 and/or a VCR (not shown). Communication between the input device 10 and the video receiving device 60 occurs using wireless communication techniques, e.g., RF or infrared signals. To this end, infrared signals may be locally transmitted via a transmitter 30 and received via an infrared detector 61 and/or by input device 10. Moreover, input device 10 can transmit signals for television control which are received by detectors 31 and/or 61, and can also transmit and receive signals from base station 20, such as when stored data in input device 10 is forwarded through base station 20 to a survey provider. Alternatively, an RF receiver 66 can be connected to set-top box 30, which can then also serve as a base station for receiving signals from input device 10 and transmitting the received signals over a twisted wire pair.

As is known in the art, a content server source 82 supplies the program, such as a video signal, which is encoded by an encoder 86 so as to include information supplied by survey services 82, such as survey questions. The resulting encoded signal is provided to the user's premises via a transport provider, such as a central provider 50, a video services network 40, or a traditional provider 68. Alternatively, the encoded survey questions are transmitted to computer 64 e.g., via an ISDN line of telephone/computer network 80. The telephone/computer network 80 provides communication between the survey services provider 84, computer 64 and input device 10. Note that elements 40, 50 and 68 are shown in FIG. 1 as being located on a user's premises for illustration purposes only. As is known in the art, the services network and providers are typically located outside of the user's premises and signals produced therefrom are received within the user's premises.

Input device 10 functions as an input device for receiving a viewer's responses to queries, such as survey questions, which are posed to him using the display device or using the input device 10 itself, as explained below. Input device 10 may also store data received from a video receiver device and forward that data to the survey source 82. Additionally, input device 10 may also be employed as the remote control for the video display device 60.

The data captured by the input device 10 from the video display device 60 may be received in the form of imperceptible luminance data, such as an electronic water mark or “finger print” signal. Such a water mark may be incorporated in a video signal at the time of the production, or at a later date. Alternatively, the data captured may be received in the form of an audio signal information which is incorporated in the audio portion of a video signal either at the time of the production, or at a later date. Regardless of its particular form, the data is used for identifying particular programming and advertisements via electronic means. The operation of the input device 10 is more fully described in commonly owned U.S. patent application Ser. No. 08/339,538, filed Nov. 15, 1994, the entire content of which is incorporated herein by reference.

The survey questions which viewers are requested to answer may seek a viewer's reactions to particular programming or advertisements. To this end, each viewer may be presented with a script of survey questions, e.g. by displaying them on the video display device 60 or on a small display 12 on device 10. Alternatively, voice processing or recorded speech can present the questions(s) of the survey audibly through a speaker located in device 10 and/or through a speaker in the video receiving device 60. The questions are provided by the survey services provider 84 and transmitted as described above.

Each viewer has a viewer identification information to distinguish individual viewers from one another. The identification information may be assigned to the viewer or selected by the viewer, depending on the options provided by the implementor. The identification information may be a code such as a personal identification number (PIN); a viewer's voice print; a fingerprint; or the like.

The displayed questions are answered by pressing appropriate buttons 14 contained on the input device 10 or by using automated speech recognition provided as an application in the computer network 80. The responses to the survey questions may be used to establish viewer demographics or a profile of each viewer, such as the viewer's age, sex, preferred times and days of the week for watching television, etc.

Information entered by viewers in response to the survey questions may be stored for access by the survey services provider 84. Such information may be accessed by the survey services provider by identifying a viewer from a corresponding user address, e.g., the user's telephone number, by utilizing caller identification techniques. For example, if input device 10 conveys viewer query responses to the survey provider via a telephone network, when such conveyance occurs the viewer's telephone number may be identified by the survey provider. Once initial information, such as viewer profile information including age, sex, viewing preferences, etc., provided by a viewer is stored, future retrieval of the information can be accomplished when subsequent responses to survey questions are forwarded by input device 10 to the survey provider.

Once viewer profile information has been entered, each viewer can be subsequently identified by the viewer's corresponding identification code. For example, when a viewer activates the video receiving device 60, the viewer can input his or her corresponding identification code so that input device 10 can determine which viewer is watching display device 60. Alternatively, input device 10 can be configured to enable activation of display device 60 only after a viewer identification code is input, thus assuring accurate record keeping. Once activated, device 10 will prompt a viewer to identify all other viewers who are presently in the viewing environment.

When viewing commences and a program is displayed on display device 60, the program identification information will be received by input device 10. Using information, captured from display device 60, such as the water mark information described above, input device 10 can automatically identity of each program or advertisement displayed on the display device. Advantageously, this alleviates the inconvenience of requiring a viewer to manually input the identity of a currently viewed program. With the program so-identified, survey questions can be presented to the viewer while the viewer is watching a particular program and responses to such survey questions can be solicited and obtained in real time, as the viewer is viewing the particular program material. The viewer responses will be stored in input device 10 and forwarded, for example, at regular intervals, to the survey provider via a telephone, cable or internet connections.

To account for a viewer who selects a program and then ceases viewing it but still allows it to remain displayed on the television, a smart reminder function is included in input device 10. This function causes input device 10 to periodically prompt the viewer to confirm that the viewer is still watching the program and, if so, to enter updated data in the form of responses to queries. This function is particularly useful for surveys that require or benefit from real time, interval specific observations, such as for soliciting immediate viewer opinion about or reaction to a particular advertisement. The reminder can take the form of an audio tone or sound, e.g., a buzzer, or a visible reminder such as a message displayed on the receiving device 60 or display 12.

In another preferred embodiment, input device 10 will display a menu containing a broadcast history of television programming for each day. Such a feature is useful, for example, when a viewer watches television programming at a location other than the viewer's home. Under such circumstances, when a viewer returns home the viewer can activate the menu on the input device 10, which can be displayed either on display device 60 or the display 12. The viewer may then select the particular programs that were viewed at another location. Thus, input device 10 will be able to collect an accurate record of the viewing habits for each viewer in an environment which it can transmit as described above. When an ADSI telephone, television or alternate controls screen device is unavailable, the program history may be presented via a voice-based interface over conventional telephone using a voice response unit, or on a computer interface.

It will be understood that various omissions, substitutions, and changes in the form, details and operation of the devices illustrated may be made by those skilled in the art without departing from the spirit of the invention. For example, although the preferred embodiment has been described in the context of video ratings data, i.e., television, internet, etc., it will be readily apparent to those having ordinary skill in the art that the present invention can be equally applied to audio media such as radio. For such applications, ratings data from audio program listeners can be gathered in a manner more fully set forth above. It is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. A device for (i) obtaining real time responses to survey queries concerning media programming, said media programming being conveyed to a user on a primary receiving device, and (ii) for coordinating the responses with programming identifiers, comprising:
means for automatically identifying, in real time, programming experienced by a user on the primary receiving device, said identifying means being located in an environment containing the primary receiving device;
means for receiving information from a user in response to prompts supplied to said user, said receiving means being located in the environment containing the primary receiving device and being in communication with said identifying means for receiving identification of programming experienced by the user on the primary receiving device; and
means for transmitting an indication of said identified programming and an indication of said received user information to a location remote from said viewing environment.

2. The device of claim 1, wherein said information receiving means includes a display for visually conveying queries soliciting user responses.

3. The device of claim 1, wherein at least some of the media programming conveyed to a user contains a unique code and wherein said identifying means identifies media programming by detecting the unique code.

4. The device of claim 1, wherein said information receiving means includes a speaker for audibly conveying queries soliciting user responses.

5. The device of claim 1, wherein said primary receiving device conveys queries soliciting user responses.

6. The device of claim 1, wherein said information receiving means and the primary receiving device conveys to a user a recent history of media programming.

7. The device of claim 6, wherein said information receiving means further comprises means for allowing the user to use said conveyed history to input, to said identification of media programming that was conveyed to the user from a remote receiving device.

8. The device of claim 1, wherein said means for receiving information receives information about past programs displayed on the primary receiving device for allowing the user to use the history to input, to said, identification of media programming that was conveyed to the user from a remote receiving device.

9. The device of claim 1, wherein said information receiving means includes a reminder feature for periodically reminding the user to respond to conveyed survey queries.

10. The device of claim 1, further comprising a corresponding address for providing access by an end user to demographics information input to said when the corresponding address is detected.

11. A method for use by a portable device for (i) obtaining real time responses to survey queries concerning media programming, said media programming being conveyed to a user on a primary receiving device, and (ii) for coordinating the responses with programming identifiers, the method comprising the steps of:
identifying, in real time, programming experienced by a user on the primary receiving device by detecting a unique code associated with each of the experienced media programming;
providing queries to said viewer, said survey queries concerning a media program experienced by the user and soliciting user responses to the survey queries;
receiving from a viewer information concerning identification of said viewer and responses to said queries; and
transmitting programming identification, query responses, and viewer identification to a location remote from said primary receiving device and said portable device.

12. The method of claim 11, further comprising the step of assigning identification criteria to the user.

13. The method of claim 11, wherein said providing step comprises the step of displaying a script on a visual display for soliciting demographic information from the user.

14. The method of claim 13, further comprising the step of displaying a recent history of media programming on said display.

15. The method of claim 11, further comprising the step of periodically reminding the user to enter responses to survey queries.

16. In a device for (i) obtaining real time responses to survey queries concerning media programming, said media programming being conveyed to a user on a primary receiving device, and (ii) for coordinating the responses with programming identifiers, the device including an identifying device located in an environment containing the primary receiving device for identifying, in real time, programming experienced by a user on the primary receiving device, and a transmitter for transmitting information to an end user, said improvement comprising:
means for receiving, while media programming is being conveyed to the user, identification and demographics information from the user and for receiving user input of responses to survey queries conveyed to the user from a survey provider through one of said and the primary receiving device, said receiving means being located in the environment containing the primary receiving device and being in communication with said identifying means for receiving identification of programming experienced by the user on the primary receiving device, the information transmitted by the transmitter being received by said receiving means and including at least one of the identification and demographics information, the responses to survey queries and the identification of programming.

17. The improvement of claim 16, wherein said receiving meas includes a display for visually conveying survey queries provided by a survey provider, said display also conveying a script of demographic queries for soliciting user responses.

18. The improvement of claim 16, wherein said receiving means includes a speaker for audibly conveying survey queries provided by a survey provider, said speaker also conveying a script of demographic queries for soliciting user responses.

19. The improvement of claim 16, wherein one of said receiving means and the primary receiving device conveys to a user a recent history of media programming for allowing the user to use the history to input, to said receiving means, identification of media programming that was conveyed to the user from a remote receiving device.

20. The improvement of claim 16, wherein said receiving means includes a reminder feature for periodically reminding the user to respond to conveyed survey queries.

21. The improvement of claim 16, wherein said receiving means includes a corresponding address for providing access by an end user to demographics information input to said receiving means when the corresponding address is detected.

22. A device for use with a primary receiving device located in an environment from which media programming is conveyed in viewer perceivable form, the device comprising:
means for uniquely identifying the user;
means for receiving identification signals identifying media programming broadcast on the primary receiving device; and
means for transmitting the user information in association with the media programming identification signal to a location remote from the viewing environment.

23. The device of claim 22, further comprising means for obtaining, from the user, profile information about the user.

24. The device of claim 22, wherein said identifying means is operable when the primary receiving device is activated.
